(19) United States
(12) Patent Application Publication
(10) Pub. No.: US 2024/0335974 A1
(43) Pub. Date: Oct. 10, 2024

(54) A METHOD TO PRODUCE A VENEERED PANEL AND A VENEERED PANEL

(71) Applicant: VÄLINGE INNOVATION AB, VIKEN (SE)

(72) Inventor: Rickard RITTINGE, FÖRSLÖV (SE)

(73) Assignee: VÄLINGE INNOVATION AB, Viken (SE)

(21) Appl. No.: 18/576,294

(22) PCT Filed: Jul. 1, 2022
(86) PCT No.: PCT/SE2022/050668

§ 371 Date: Jan. 3, 2024

(30) Foreign Application Priority Data
Jul. 15, 2021 (SE) 2150948-4

(51) Int. Cl. B27G 11/00; B27D 1/04; B27D 3/04; B32B 3/26; B32B 21/02; B32B 21/13; B32B 21/14; B32B 37/10; B32B 37/12; B32B 37/20; B32B 38/00; E04F 15/04

(52) U.S. Cl. CPC B27G 11/00; B27D 1/04; B32B 3/266; B32B 21/02; B32B 21/13; B32B 21/14; B32B 37/10; B32B 37/1284; B32B 37/20; B32B 38/0012; E04F 15/045; B27D 3/04; B32B 2255/08; B32B 2255/26; B32B 2307/7376; B32B 2309/02; B32B 2309/12; B32B 2317/16; B32B 2607/00

(57) ABSTRACT

A method to produce a veneered panel, including providing a core, providing a first wood veneer layer, providing a second wood veneer layer having at least one open structure, arranging the first wood veneer layer on a first surface of the core with a first binder layer, arranging the second wood veneer layer on the first wood veneer layer with a second binder layer including a second binder, pressing the core, the first wood veneer layer and the second wood veneer layer together to form a veneered panel, wherein, during pressing, the first wood veneer layer is pressed into said at least one open structure of the second wood veneer layer, and after pressing, the first wood veneer layer at least partly fills said at least one open structure of the second wood veneer layer. Also, a veneered panel.

### TECHNICAL FIELD

Embodiments of the present disclosure relate to a method to produce a veneered panel, and such a veneered panel.

### TECHNICAL BACKGROUND

Floor coverings having a wooden surface may be of several different types. Solid wood floorings are formed of a solid piece of wood in form of a plank.

Engineered wood floorings are formed of a surface layer of wood glued to a core. The core may be a lamella core or a wood-based panel, such as plywood, MDF or HDF. The wooden surface layer may, as an example, have a thickness of 2.5-10 mm.

A wooden floor covering may also be formed by gluing a wood veneer to a core, for example, a wood-based panel, such as particleboard, MDF or HDF. Wood veneer is a thin wood layer, for example, having a thickness of 0.3-1 mm. A flooring with a separate surface layer glued to a core of, for example, HDF or plywood, is more moisture stable than solid wood floorings.

Compared to solid wood and engineered wood floorings, wood veneer floorings can be produced to a lower cost and less wood resources are consumed since only a thin wood layer is used. However, a wood veneer layer cannot be sanded as a solid wood or engineered wood flooring can be.

In order to improve impact resistance of a wood veneer flooring, a sub-layer may be arranged between the wood veneer layer and the core. WO 2009/065769 discloses a thin surface layer, such as wood veneer layer, which is applied on a sub-layer comprising, for example, cork or wood fibres mixed with a binder. The sub-layer is applied on a wood fibre based core.

Depending on the quality of the wood veneers, the wood veneer may include open structures, such as knots, holes, cracks, etc. The open structures may extend through the wood veneer, or may extend partly through the wood veneer. In traditional engineered wood floorings, such open structures are filled with putty after the wood surface layer has been glued to the core. In order to rationalize production, such an extra production step is undesirable.

WO 2015/105456 discloses a method to produce a veneered element comprising a substrate, a veneer layer, and a sub-layer arranged between the substrate and the wood veneer layer. The sub-layer comprises a binder and may be applied in powder form, in liquid form, as a paste, or as a sheet. The sub-layer may fill any cracks, holes, or knots of the veneer layer. Cracks, holes or knots are filled with material having the composition, properties and appearance of the sub-layer.

WO 2020/127556 discloses a method to produce a wood-based material in which a high-quality veneer is combined with an inexpensive veneer. A thin expensive oak veneer, e.g., 0.6 mm thick, is arranged on a thick inexpensive poplar veneer, e.g., 1.5 mm thick, to form a thick veneer surface on a carrier plate. The veneers are adhered to each other by a synthetic resin applied in excess. Excess refers to the amount of synthetic resin that, based on the amount of synthetic resin required for gluing, is additionally applied to the carrier plate and/or veneer. During pressing, the synthetic resin liquefies and is pressed into the less dense veneer.

### SUMMARY

It is an object of at least embodiments of the present disclosure to provide an improvement over the above described techniques and known art.

According to a first aspect, a method to produce a veneered panel is provided. The method comprises:
providing a core,
providing a first wood veneer layer,
providing a second wood veneer layer having at least one open structure,
arranging the first wood veneer layer on a first surface of the core with a first binder layer comprising a first binder applied intermediate the first surface of the core and the first wood veneer layer,
arranging the second wood veneer layer on the first wood veneer layer with a second binder layer comprising a second binder applied intermediate the first wood veneer layer and the second wood veneer layer,
pressing the core, the first wood veneer layer and the second wood veneer layer together to form a veneered panel,
wherein, during pressing, the first wood veneer layer is pressed into said at least one open structure of the second wood veneer layer, and after pressing, the first wood veneer layer at least partly fills said at least one open structure of the second wood veneer layer.

The first binder layer may comprise the first binder and at least one filler.

The open structure may be an opening in the wood veneer layer, such as a knot, a hole, a crack, or similar. The open structure may have an extension from one surface of the second wood veneer layer to an opposing surface of the second wood veneer layer, or may have an extension less than the thickness of the second wood veneer layer.

The open structure may extend in a direction perpendicular to the first surface of the core.

By at least partly filled is understood to mean that an upper surface of the first wood veneer layer may be in level with an upper surface of the second wood veneer layer, or that the upper surface of the first wood veneer layer is positioned at a distance from a lower surface of the second wood veneer layer, facing the first wood veneer layer. In one example, a portion of upper surface of the first wood veneer layer is positioned closer to the upper surface of the second wood veneer layer than to the lower surface of the second wood veneer layer in the open structure.

In the open structure, a portion of the first wood veneer layer may extend into the second wood veneer layer.

The second wood veneer layer may form an uppermost veneer layer of the veneered panel.

The second wood veneer layer may form an uppermost layer of the veneered panel. The second wood veneer layer may form an uppermost decorative layer of the veneered panel. The second wood veneer layer may form an uppermost wood-based layer of the veneered panel.

The open structure may be visible from the uppermost layer of the veneered panel. The open structure may be visible when the veneered panel is installed and used as a building panel.

The open structure may only be filled, or at least partly filled, with material originating from the first wood veneer layer.

The open structure may be open at an upper surface of the second wood veneer layer. The open structure may not be covered by any additional wood veneer layer.

The second wood veneer layer may be intended to form a surface visible when being installed and used as a building panel.

Prior to pressing, a balancing layer may be arranged on a second surface of the core, opposite the first surface of the core.

After pressing, the veneered panel may consist of the core, the first wood veneer layer, the second wood veneer layer, optionally provided with a coating, and the balancing layer.

The first wood veneer layer may be compressible. The first wood veneer layer may be more compressible than the second wood veneer layer. The first wood veneer layer may be compressible to a compression thickness being approximately 80% of its original thickness, or compressible to a compression thickness being less than 80% of its original thickness. For example, the original thickness being the thickness of the first wood veneer prior to pressing, such as when it is arranged on the first veneer layer prior to pressing.

The first wood veneer layer may have a thickness equal to or less than 1 mm prior to pressing. The first wood veneer layer may have a thickness equal to or less than 0.6 mm prior to pressing.

The first wood veneer layer and the second wood veneer layer together may have a thickness equal to or less than 1.6 mm, such as equal to or less than 1.2 mm, after pressing.

The first binder layer may further comprise at least one filler. The filler may be organic, such as wood particles, and/or inorganic, such as barium sulphate. The first binder may be mixed with said at least one filler when applied.

The first binder may be applied in powder form.

The first binder may be applied in liquid form, and may be dried prior to pressing.

The second wood veneer layer may be a sliced wood veneer layer.

The first wood veneer layer may be a rotary cut wood veneer layer.

The second wood veneer layer may be or comprise an oak veneer.

The first wood veneer layer may be or comprise a birch veneer.

The method may further comprise brushing the first wood veneer layer and the second wood veneer layer after pressing, into a brushing depth extending into the first wood veneer layer.

The first binder may be applied in an amount of less than 100 g/m².

The second binder may be applied in an amount of less than 100 g/m².

The first binder may be applied in an amount of less than 300 g/m².

The second binder may be applied in an amount of less than 150 g/m².

The pressing may comprise applying a pressure of at least 20 bar, such as 20-100 bar, at a temperature of at least 160° C., such as 160-250° C., during at least 10 s, such as 10-100 s.

The pressing comprises may comprise applying a pressure of at least 30 bar, such as 30-80 bar, at a temperature of at least 180° C., such as 180-250° C., during at least 40 s, such as 40-100 s.

The core may be a wood based panel, such as wood fibre based panel.

According to a second aspect, a veneered panel is provided. The veneered panel comprises
a core,
a first wood veneer layer arranged on the first surface of the core, wherein the first wood veneer layer is adhered to the core by a first binder layer arranged intermediate the first surface of the core and the first wood veneer layer, and
a second wood veneer layer arranged on the first wood veneer layer, wherein the second wood veneer layer is adhered to the first wood veneer layer by a second binder layer arranged intermediate the first wood veneer layer and the second wood veneer layer, and wherein the second wood veneer layer has at least one open structure,
wherein the first wood veneer layer at least partly fills said at least one open structure of the second wood veneer layer.

The first binder layer may comprise a first binder and at least one filler.

The open structure may be an opening in the wood veneer layer, such as a knot hole, a hole, a crack, or similar. The open structure may have an extension from one surface of the second wood veneer layer to an opposing surface of the second wood veneer layer, or may have an extension less than the thickness of the second wood veneer layer.

The open structure may extend in a direction perpendicular to the first surface of the core.

By at least partly filled is understood to mean that an upper surface of the first wood veneer layer may be in level with an upper surface of the second wood veneer layer, or that the upper surface of the first wood veneer layer is positioned at a distance from a lower surface of the second wood veneer layer. In one example, a portion of the upper surface of the first wood veneer layer is positioned closer to the upper surface of the second wood veneer layer than to the lower surface of the second wood veneer layer in the open structure.

In the open structure, a portion of the first wood veneer layer may extend into the second wood veneer layer.

The second wood veneer layer may form an uppermost veneer layer of the veneered panel.

The second wood veneer layer may form an uppermost layer of the veneered panel. The second wood veneer layer may form an uppermost decorative layer of the veneered panel. The second wood veneer layer may form an uppermost wood-based layer of the veneered panel.

The open structure may be visible from the uppermost layer of the veneered panel. The open structure may be visible when the veneered panel is installed and used as a building panel.

The open structure may only be filled, or at least partly filled, with material originating from the first wood veneer layer.

The open structure may be open at an upper surface of the second wood veneer layer. The open structure may not be covered by any additional wood veneer layer.

The second wood veneer layer may be intended to form a surface visible when being installed and used as a building panel.

Prior to pressing, a balancing layer may be arranged on a second surface of the core, opposite the first surface of the core.

After pressing, the veneered panel may consist of the core, the first wood veneer layer, the second wood veneer layer, optionally provided with a coating, and the balancing layer.

The first wood veneer layer may be compressible. The first wood veneer layer may be more compressible than the second wood veneer layer. The first wood veneer layer may be compressible to a compression thickness being approximately 80% of its original thickness, or being compressed to a compression thickness being less than 80% of its original thickness. For example, the original thickness being the thickness of the first wood veneer prior to pressing, such as when it is arranged on the first veneer layer prior to pressing.

The first wood veneer layer may have a thickness less than 1 mm. The first wood veneer layer may have a thickness equal to or less than 0.6 mm.

The first wood veneer layer and the second wood veneer layer together may have a thickness equal to or less than 1.6 mm, such as equal to or less than 1.2 mm.

The first binder layer may further comprise at least one filler. The filler may be an organic filler, such as wood particles, and/or inorganic filler, such as barium sulphate. The first binder may be mixed with said at least one filler.

The second wood veneer layer may be a sliced wood veneer.

The first wood veneer layer may be a rotary cut wood veneer.

The second wood veneer layer may be or comprise an oak veneer.

The first wood veneer layer may be or comprise a birch veneer.

### BRIEF DESCRIPTION OF THE DRAWINGS

The present disclosure will by way of example be described in more detail with reference to the appended schematic drawings, which show examples of the present disclosure.

FIG. 1 shows schematically a method to produce a veneered panel.

FIG. 2 shows schematically a method to produce a veneered panel.

FIG. 3 shows a veneered panel produced according to the methods disclosed in FIG. 1 or in FIG. 2.

FIG. 4 shows a brushing device.

### DETAILED DESCRIPTION

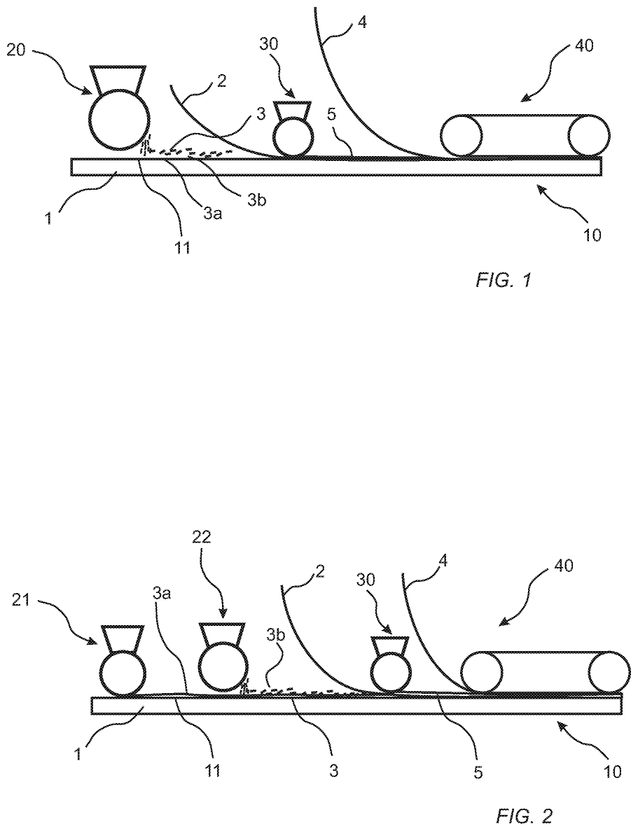

FIG. 1 shows a method to produce a veneered panel 10. The veneered panel 10 may be adapted to form a building panel, such as a floor panel, a wall panel, a furniture component, a building component, a worktop, etc. The veneered panel 10 may be divided into individual panels, and may be provided with a mechanical locking system configured to connect a panel to an adjacent panel.

A core 1 is provided. The core 1 may be a wood-based board, such as MDF or HDF board. The core 1 may be a plywood board. The core 1 may be a lamella core. The core 1 may be a particleboard. The core 1 may be a thermoplastic board. The core 1 is preferably produced prior to the present method.

The core 1 may be wood-fibre based. The core 11 may comprise a binder and fillers, such as organic and/or inorganic fillers.

In one example, the core 1 is a single-layered core, and is not a multi-layered core, such as a plywood. In one example, the core 1 is different from the veneered layers, such as in material or construction. In one example, the core 1 is at least 2 times, such as 2-20 times, such as 3-10 times, as thick as the total thickness of the first veneer layer and a second veneer layer. The core 1 may be free from veneer layers.

A thickness of the core 1 may be 3-40 mm, such as 3-12 mm.

On a first surface 11 of the core 1, a first binder layer 3 is applied. In the example shown in FIG. 1, the first binder layer 3 is applied in powder form. The first binder layer 3 comprises a first binder 3a. In the example shown in FIG. 1, the first binder 3a is applied in powder form. Various forms of granules are also intended to be included by the binder being in powder form. The first binder 3a may be a thermosetting binder, such as an amino resin, for example, melamine formaldehyde resin or urea formaldehyde resin. The thermosetting binder may be urea formaldehyde, phenol formaldehyde, melamine formaldehyde, polyurethane, polyester, emulsion polymer isocyanate (EPI), or a combination thereof. As an alternative, the first binder 3a may be a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof. The first binder 3a may comprise a hot melt or pressure sensitive adhesive. The first binder 3a may be an acrylic resin or a methacrylic resin.

The first binder 3a may be applied in an amount of less than 100 g/m², such as 50-100 g/m². In one example, the first binder 3a may be applied in an amount of less than 300 g/m², such as 50-300 g/m², such as 100-250 g/m². The first binder 3a is applied in an amount required to adhere a first wood veneer layer 2 to the first surface 11 of the core 1. No superfluous amount of the first binder 3a is applied.

The first binder layer 3 may further comprise one or several fillers 3b, such as organic fillers and/or inorganic fillers. The fillers may be organic fillers, such as wood particles, or other types of lignocellulosic or cellulosic particles. The fillers may be inorganic fillers, such as barium sulphate, calcium carbonate, limestone, kaolin, etc. Organic and inorganic fillers may be combined.

The fillers may be applied in an amount of 75-150 g/m². In one example, the fillers may be applied in an amount of 75-300 g/m². If more than one filler is applied, the amount specified refers to amount of fillers in total. The amount of fillers applied may be similar as the amount of the first binder 3a applied.

In the example shown in FIG. 1, the first binder 3a and the filler 3b are applied as a mix. The mix may be applied by an application device 20 as in FIG. 1, such as a scattering device. In other examples, the fillers 3b may be applied separately from the first binder 3a.

The mix including the first binder 3a and the filler 3b may further comprise additives and pigments. For example, the pigments may be applied in an amount of 0-50 g/m². For example, the additives may be applied in an amount of 0-100 g/m².

The mix may be applied in an amount of total 200-600 g/m². The mix may comprise 30-70 wt % of the first binder 3a, 10-60 wt % of the fillers, 0-30 wt % of optional additives, and 0-10 wt % of optional pigments.

The first binder 3a and the filler 3b form a first binder layer 3 when applied on the first surface 11 of the core 1.

After the first binder layer 3 has been applied on the core 1, a first wood veneer layer 2 is applied on the first binder layer 3. The first binder layer 3 is positioned between the first surface 11 of the core 1 and the first wood veneer layer 2.

As an alternative or complement, the first binder layer 3 of the above type may be applied on a surface of the first wood veneer layer 2. The first wood veneer layer 2 may thereafter be applied on the first surface 11 of the core 1, such that the first binder layer 3 is arranged between the first surface 11 of the core 1 and the first wood veneer layer 2.

The first wood veneer layer 2 may have a thickness less than 1.5 mm as measured prior to pressing. In one example, the first wood veneer layer 2 has a thickness equal to or less than 1 mm, such as a thickness equal to or less than 0.6 mm, as measured prior to pressing. For example, the thickness may be 0.3-1.5 mm. The first wood veneer layer 2 may be a sliced wood veneer. The first wood veneer layer 2 may have a surface substantially free from open structures, such as knots, holes and cracks. In one example, the first wood veneer layer 2 may be a birch veneer. In another example, the first wood veneer layer 2 may be a pine veneer.

As described above, the first binder 3a is applied in an amount required for adhering the first wood veneer layer 2 to the core 1. In one example, the first binder 3a is not applied in a superfluous amount, and the first binder 3a does not permeate the first wood veneer layer 2, or at least not permeate completely through the first wood veneer layer 2.

The first wood veneer layer 2 may be compressible. By being compressible, the first wood veneer layer 2 may be pressed into any open structure of a second wood veneer layer applied above the first wood veneer layer 4. For example, a portion of the first wood veneer layer, in an open structure of the second wood veneer layer, after pressing, may not be compressed, or may be compressed less than the remainder of the first wood veneer layer not below an open structure of the second wood veneer layer.

A second wood veneer layer 4 is applied on the first wood veneer layer 2. Between the first wood veneer layer 2 and the second wood veneer layer 4, a second binder layer 5 is arranged.

The first wood veneer layer 2 and the second wood veneer layer 4 may be the only veneer layers. The first wood veneer layer 2 may be free of open structures that extend through the first wood veneer layer 2, from a lower surface to an upper surface.

The second binder layer 5 comprises a second binder 5a. The second binder 5a may be of the same type as the first binder 3a. The second binder 5a may be a thermosetting binder, such as an amino resin, for example, melamine formaldehyde resin or urea formaldehyde resin. The thermosetting binder may be urea formaldehyde, phenol formaldehyde, melamine formaldehyde, polyurethane, polyester, emulsion polymer isocyanate (EPI), or a combination thereof. As an alternative, the second binder 5a may a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof. The second binder 5a may comprise a hot melt or pressure sensitive adhesive. The second binder 5a may be an acrylic resin or a methacrylic resin.

In the example shown in FIG. 1, the second binder 5a is applied in liquid form. Further, in the example in FIG. 1, the second binder 5a is applied on the first wood veneer layer 2. In FIG. 1, the second binder 5a is applied on a surface of the first wood veneer layer 2 intended to face the second wood veneer layer 4.

In an alternative example, the second binder 5a of the second binder layer 5 may be applied on a surface of the second wood veneer layer 4 intended to face the first wood veneer layer 2.

The second binder 5a may be applied in an amount of less than 100 g/m². In one example, the second binder 5a may be applied in an amount of less than 150 g/m², such as 50-150 g/m². The second binder 5a is applied in an amount required for adhering the second wood veneer layer 4 to the first wood veneer layer 2. In one example, the second binder 5a is not applied in a superfluous amount, and the second binder 5a does not permeate the second wood veneer layer 4, or at least not permeate completely through the second wood veneer layer 4.

For example, if the second binder layer 5 is applied as approximately a 50/50 solution, comprising approximately 50 wt % of the second binder 5a and approximately 50 wt % water, the second binder layer 5 may be applied in an amount of less than 200 g/m².

In one example, the second binder layer 5 is applied as a solution comprising 30-70 wt % water, such as 50 wt % water, and 30-70 wt % of the second binder, such as 50 wt % of the second binder.

After being applied, the second binder layer 5 is dried prior to pressing.

The second wood veneer layer 4 comprises at least one open structure 8. The open structures 8 may be naturally occurring in the wood veneer, or may be formed in the second wood veneer layer 4. The open structures may be holes, such as holes, knots, cracks, and other openings, in the wood veneer surface. At least one of the open structures may extend through the second wood veneer layer 4, from a lower surface to an upper surface.

The second wood veneer layer 4 may have a thickness equal to or less than 1 mm, such as equal to or less than 0.6 mm, as measured prior to pressing. For example, the thickness may be 0.3-1 mm. The second wood veneer layer 4 may be an oak veneer. The second wood veneer layer 4 may be a rotary cut wood veneer.

A balancing layer (not shown in FIG. 1) may be applied to a second surface 12 of the core 1, opposite the first surface 11 and opposite the first wood veneer layer 2.

After the first wood veneer layer 2, the second wood veneer layer 4, and optionally the balancing layer, are applied, pressure and preferably also heat is applied to press the assembly together to form a veneered panel 10. The first wood veneer layer 2 and the second wood veneer layer 4 are pressed and adhered to each other simultaneously as being pressed and adhered to the core 1. Preferably, no pre-pressing for adhering the first wood veneer layer 2 to the second wood veneer layer 4 is performed.

Pressure may be applied in a press 40. The press may be a stationary or continuous press.

The pressure applied may be in the range of 30-60 bar. The pressure time may be 10-60 s. The temperature applied may be in the range of 120-250° C. In one example, pressure applied is approximately 50 bar, pressing temperature approximately 190° C., and pressing time approximately 45 s.

During pressing, the first wood veneer layer 2 is adhered to the core 1, and the second wood veneer layer 4 is adhered to the first wood veneer layer 2.

After pressing, the first wood veneer layer 2 and the second wood veneer layer 4 may together have a thickness less than 2.5 mm. In one example, the first wood veneer layer 2 and the second wood veneer layer 4 may together have a thickness equal to or less than 2 mm after pressing. In one example, the first wood veneer layer 2 and the second wood veneer layer 4 may together have a thickness equal to or less than 1.6 mm after pressing. In one example, the first wood veneer layer 2 and the second wood veneer layer 4 may together have a thickness equal to or less than 1.2 mm after pressing. For example, the first wood veneer layer 2 and the second wood veneer layer 4 may together have a thickness of 0.6-2.5 mm, such as 0.8-1.5 mm.

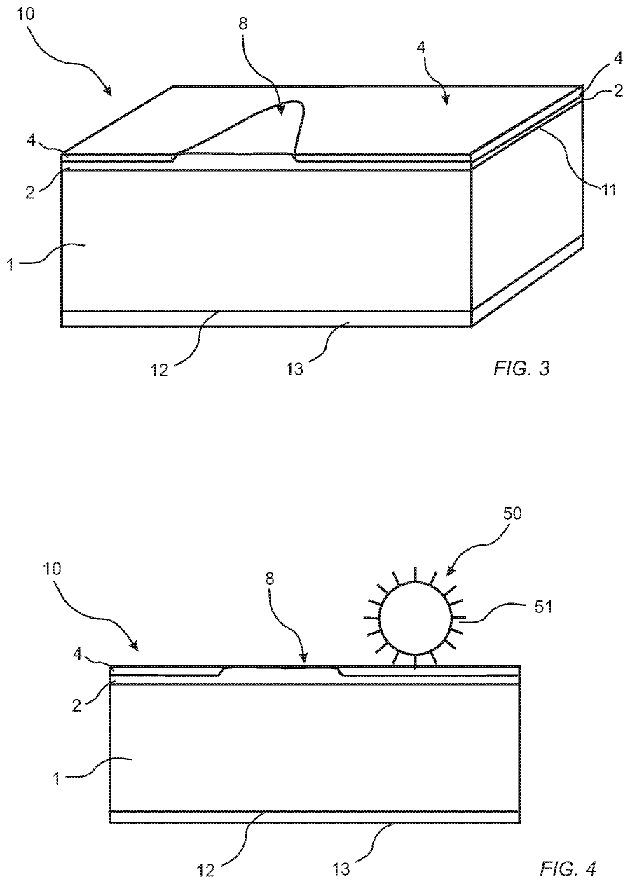

During pressing, the first wood veneer layer 2 is pressed into at least one open structure 8 in the second wood veneer layer 4. After pressing, the open structure 8 is at least partly filled with the first wood veneer layer 2, which is shown in more details in FIG. 3.

In one example, at such an open structure 8, an upper surface of the first wood veneer layer 2 may be in level with an upper surface of the second wood veneer layer 4, such that the open structure 8 is completely filled. In one example, at such an open structure 8, an upper surface of at least a portion of the first wood veneer layer 2 may be in level with an upper surface of the second wood veneer layer 4. In one example, the open structure 8 is at least partly filled, such that the upper surface of the first wood veneer layer 2 is positioned at a distance from a lower surface of the second wood veneer layer 4. Preferably, a portion of the upper surface of the first wood veneer layer 2 is positioned closer to the upper surface of the second wood veneer layer 4 than to the lower surface of the second wood veneer layer 4 in the open structure 8.

Thereby, there is no need, or at least a reduced need, to fill the open structure 8 of the second wood veneer layer 4 with putty or similar after pressing. The open structure 8 of the second wood veneer layer 4 is filled with wood veneer, which creates an aesthetically pleasing impression of the veneered panel. A more natural impression of the veneered panel 10 may be obtained, compared to filling an open structure with putty. Further, the first wood veneer layer 2 may contribute to the overall design of the veneered panel 10.

The first wood veneer layer 2 may fill or at least partly fill an open structure 8 in the second wood veneer layer 4 during pressing due to the thin thickness of the first wood veneer layer 2. After pressing, the open structure 8 remains at least partly filled by a portion of the first wood veneer layer 2. The first wood veneer layer 2 may have a thickness of less than 1.5 mm, such as equal to or less than 1 mm, for example, equal to or less than 0.6 mm prior to pressing. In such an example, the thin thickness of the first wood veneer layer 2 allows the first wood veneer layer 2 to fill the open structure in the second wood veneer layer 4. During pressing, a portion of the first wood veneer layer 2 is not compressed under an open structure of the second wood veneer layer 4. The portion of the first wood veneer layer 2 is allowed to fill the open structure during pressing.

In another example, by including at least one filler in the first binder layer 3, the first wood veneer layer 2 will follow the first binder layer 3 being filled with the filler or fillers during pressing, and may not be compressed at one open structure of the second wood veneer layer 4 but forced by said at least one filler to fill the open structure in the second veneer layer 4. Further, a thin wood veneer layer, such as the first wood veneer layer 2, more easily follows the first binder layer 3, at least compared to a thicker wood veneer layer.

For example, soft wood specie, such as pine or birch, more easily fill an open structure. Since a first wood veneer layer 2 of pine or birch are more compressed under solid portions of the second wood veneer layer 4 compared to a less soft veneer layer, an open structure is filled to a higher degree by the first wood veneer layer of pine or birch compared to a less soft veneer.

In one example the first wood veneer layer 2 is compressible, such as being compressed in a pressing operation at 160° C., 50 bar during 30 seconds to a thickness after pressing being approximately 80% of its original thickness, or to a thickness being less than 80% of its original thickness as measured prior to pressing; wherein only the upper press plate applies heat during pressing. In example 4, compression of several different wood species is listed. The first wood veneer layer 2 may be compressed with at least 20% of its original thickness, the original thickness being measured prior to pressing.

The first wood veneer layer 2 may be more compressible than the second wood veneer layer 4. The second wood veneer layer 4 may be compressed to a thickness after pressing being 90% of its original thickness, or to a thickness being less than 90% of its original thickness as measure prior to pressing in a pressing operation as described above with reference to compression of the first wood veneer layer 2.

Adding fillers to the first binder layer 3 improves filling of the open structure 8 in the second wood veneer layer 4. By adding a filler to the first binder layer 3, the first wood veneer layer 2 may fill the open structure to a level being closer to the upper surface of the second wood veneer layer 4, compared to a first binder layer 3 without fillers.

Further, after pressing, the veneered panel 10 may be brushed, as shown in FIG. 4. The veneered panel 10 may be brushed by a brushing device 50 comprising a roller brush 51. The roller brush 51 may be rotating. The veneered panel 10 may be deeply brushed. The veneered element 10 may be brushed into a brushing depth extending into the first wood veneer layer 2. The veneered panel 10, comprising two wood veneer layers 2, 4, may be deeply brushed, creating a more rustic appearance, without the underlying core 1 being exposed. The first wood veneer layer 2 may be partly visible after brushing.

A protective layer or coating may be applied on the upper surface of the second wood veneer layer 2. In one example, the protective layer may include at least one lacquer layer, which may be applied after pressing. In one example, a protective layer in form of a resin impregnated overlay may be applied to the upper surface of the second wood veneer layer 2 prior to pressing.

FIG. 2 shows a similar process as in FIG. 1. However, the application of the first binder layer 3 differs from the application of the first binder layer 3 disclosed above with reference to FIG. 1.

Similar to FIG. 1, FIG. 2 shows a method to produce a veneered panel 10. The veneered panel 10 may be adapted to form a building panel, such as a floor panel, a wall panel, a furniture component, a building component, a worktop, etc. The veneered panel 10 may be divided into individual panels, and may be provided with a mechanical locking system configured to connect a panel to an adjacent panel.

As described above with reference to FIG. 1, a core 1 is provided. The core 1 is of the type described above with reference to FIG. 1.

In the example shown in FIG. 2, the first binder 3a is applied in liquid form on a first surface 11 of the core 1. The first binder 3a may be a thermosetting binder, such as an amino resin, for example, melamine formaldehyde resin or urea formaldehyde resin. The thermosetting binder may be urea formaldehyde, phenol formaldehyde, melamine formaldehyde, polyurethane, polyester, emulsion polymer isocyanate (EPI), or a combination thereof. As an alternative, the first binder 3a may a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof. The first binder 3a may comprise a hot melt or pressure sensitive adhesive. The first binder 3a may be an acrylic resin or a methacrylic resin.

The first binder 3a is applied by an application device, for example, a roller 21 as shown in FIG. 2.

The first binder 3a may be applied in an amount of less than 100 g/m². In one example, the first binder 3a may be applied in an amount of less than 300 g/m², such as 50-300 g/m², such as 100-250 g/m². The first binder 3a is applied in an amount required to adhere a first wood veneer layer 2 to the first surface of the core 11. No superfluous amount of the first binder 3a is required.

In one example, the first binder 3a is applied as a 50/50 solution, comprising 50% of the first binder 3a and 50% water, the first binder 3a may be applied in an amount of less than 200 g/m².

After the first binder 3a has been applied, one or more fillers 3b is applied on the first binder 3a. The fillers may be applied by an application device, such as a scattering device 22. The fillers 3b may be organic fillers and/or inorganic fillers. Organic fillers and inorganic fillers may be combined. The fillers 3b may be organic fillers, such as wood particles, or other types of lignocellulosic or cellulosic particles. The fillers may be inorganic filler, such as barium sulphate, calcium carbonate, limestone, kaolin, etc., or a combination thereof. The fillers may be applied in an amount of 50-150 g/m². In one example, the fillers may be applied in an amount of 75-300 g/m². If more than one filler is applied, the amount specified refers to amount of fillers in total.

As a complement or alternative, fillers of the above type may be mixed with the first binder 3a.

The first binder 3a may be dried prior to applying the second wood veneer layer 4. IR may be used to dry the first binder 3a. The first binder 3a may be dried prior or after the fillers 3b being applied.

The first binder 3a and the filler/fillers 3b form a first binder layer 3 arranged on the first surface of the core 11.

In addition to the first binder 3a and the filler 3b, the first binder layer 3 may comprise additives and pigments.

After the first binder layer 3 has been applied on the core 1, a first wood veneer layer 2 is applied on the first binder layer 3 as discussed above with reference to FIG. 1. The first binder layer 3 is positioned between the first surface 11 of the core 1 and the first wood veneer layer 2. The first wood veneer layer 2 is of the type described above with reference to FIG. 1.

The first wood veneer layer may have a thickness less than 1.5 mm prior to pressing. The first wood veneer layer may have a thickness equal to or less than 1 mm, such as a thickness equal to or less than 0.6 mm, prior to pressing.

As an alternative or complement, the first binder 3a may be applied on a surface of the first wood veneer layer 2 intended to face the first surface 11 of the core 1. The first wood veneer layer 2 is thereafter applied on the first surface 11 of the core 1, such that the first binder layer 3 is arranged between the first surface 11 of the core 1 and the first wood veneer layer 2.

As described above with reference to FIG. 1, a second binder layer 5 is applied, comprising a second binder 5a. The second binder 5a and the second binder layer 5 is of the type described above with reference to FIG. 1, and is therefore not described in detail with reference to FIG. 2.

As described above with reference to FIG. 1, a second wood veneer layer is applied on the second binder layer 5. The second wood veneer layer is of the type described above with reference to FIG. 1.

The second binder 5a may be applied on a surface of the first wood veneer layer 2 intended to face the second wood veneer layer 4, as shown in FIG. 2 and described in more details above with reference to FIG. 1. As an alternative, or complement, the second binder 5 may be applied on a surface of the second wood veneer layer 4 intended to face the first wood veneer layer 2, as discussed above.

After the first wood veneer layer 2, the second wood veneer layer 4, and optionally a balancing layer (not shown in FIG. 2), are applied, pressure and preferably also heat is applied to press the assembly together to form a veneered panel 10 in a press 40. The first wood veneer layer 2 and the second wood veneer layer 4 are pressed and adhered to each other simultaneously as being pressed and adhered to the core 1. Preferably, no pre-pressing for adhering the first wood veneer layer 2 to the second wood veneer layer 4 is performed.

The press 40 and pressing parameters may be the same as described above with reference to FIG. 1. Pressure may be applied in a continuous press or stationary press.

During pressing, the first wood veneer layer 2 is adhered to the core 1, and the second wood veneer layer 4 is adhered to the first wood veneer layer 2.

The first wood veneer layer 2 and the second wood veneer layer 4 together may have a thickness less than 2.5 mm. The first wood veneer layer 2 and the second wood veneer layer 4 together may have a thickness equal to or less than 2 mm. The first wood veneer layer 2 and the second wood veneer layer 4 together may have a thickness equal to or less than 1.6 mm, such as less a thickness equal to or less than 1.2 mm, after pressing.

As discussed above with reference to FIG. 1, during pressing, the first wood veneer layer 2 is pressed into at least one open structure 8 in the second wood veneer layer 4. After pressing, the open structure 8 is at least partly filled with the first wood veneer layer 2, which is shown in more details in FIG. 3.

The discussion above relating to filling of the open structure 8 of the second wood veneer layer 4 is applicable also for the veneered panel 10 produced according to the method shown in FIG. 2.

Further, after pressing, the veneered panel 10 may be brushed. The veneered panel 10 may be deeply brushed. The veneered element 10 may be brushed into a depth extending into the first wood veneer layer 2. The veneered panel 10, comprising two wood veneer layers 2, 4, may be deeply brushed, creating a more rustic appearance, without the underlying core 1 being exposed. The first wood veneer layer 2 may be partly visible through the second wood veneer layer 4 after brushing.

A protective layer or coating may be applied on the upper surface of the second wood veneer layer 2. In one example, the protective layer may include at least one lacquer layer, which may be applied after pressing. In one example, a protective layer in form of a resin impregnated overlay may be applied to the upper surface of the second wood veneer layer 2 prior to pressing.

FIG. 3 shows a veneered panel 10 produced according to the method described with reference to FIG. 1 or FIG. 2. The veneered panel 10 comprises the core 1, the first wood veneer layer 2 adhered to the upper surface 11 of the core 1 by the first binder layer 3, the second wood veneer layer 4 adhered to the first wood veneer layer 2 by the second binder layer 5, and a balancing layer 13 adhered to the lower surface 12 of the core 1. The core 1, the first wood veneer layer 2, the second wood veneer layer 4, the first binder 3a, the first binder layer 3, the second binder 5a, and the second binder layer 5, is of the type described above and will not be described in further details.

FIG. 3 shows in more details the open structure 8 of the second wood veneer 4 after pressing. As shown in FIG. 3, a portion of the first wood veneer layer 2 at least partly fills the open structure 8 of the second wood veneer layer 4. The first wood veneer layer 2 may substantially fill the open structure 8 of the second wood veneer layer 2, as shown in FIG. 3. In FIG. 3, an upper surface of the first wood veneer layer 2 is in level with an upper surface of the second wood veneer layer 4 in the open structure 8. In another example, the upper surface of the first wood veneer layer 2 may be positioned between the upper surface and the lower surface of the second wood veneer layer 4. Preferably, the upper surface of the wood veneer layer 2 is positioned closer to the upper surface of the second wood veneer layer 4 than the lower surface of the second wood veneer layer 4.

The core 1, the first wood veneer layer 2 and the second wood veneer layer 4 all have a planar extension in horizontal planes. The planar extension of the core 1, the first wood veneer layer 2 and the second wood veneer layer 4 are parallel to each other.

In the above described methods, the first binder layer 3 may be applied to the core 1, and/or may be applied to the first wood veneer layer 2. The second binder layer 5 may be applied to the first wood veneer layer 2, and/or may be applied to the second wood veneer layer 4.

### EXAMPLES

### Reference, Example 1

400 g/m² of a powder mixture, comprising 40 wt-% wood fibres, 10 wt-% aluminium oxide, 49.5 wt-% melamine formaldehyde resin and 0.5 wt-% of carbon black was scattered on a 10.0 mm HDF board for forming a sub-layer. The powder layer forming the sub-layer was sprayed with 20 g/m² of an aqueous solution of a release agent. A 0.6 mm oak veneer layer was positioned on the sub-layer prior to pressing the assembly in a short cycle press for 30 seconds at 40 bars with a press plate temperature of 160° C. The resulting product was a veneered HDF having pores and cracks in the veneer layer filled with the cured powder mixture of the sub-layer.

### Example 2

A first liquid binder in form of 50 wt-% melamine formaldehyde dissolved in water is applied by rolling in an amount of approximately 150 g/m² on a first surface of a HDF board, forming a core.

A first wood veneer layer in form of a birch veneer having a thickness of 0.55 mm and being rotary cut is provided.

A second binder is applied on the first wood veneer. The second binder is in form of a 50 wt-% melamine formaldehyde dissolved in water, applied by rolling in an amount of approximately 150 g/m².

A second wood veneer in form of a sliced oak veneer nature grade having a thickness of 0.57 mm is provided. The second wood veneer layer comprises open structures in form of holes, knots and cracks.

The first binder and the second binder are air dried at low temperature to a moisture content of about 6-10 wt %.

The first wood veneer layer is applied on the HDF board with the dried first binder arranged between the HDF board and the first wood veneer layer. The second wood veneer layer is applied on the first wood veneer layer with the dried second binder between the first wood veneer layer and the second wood veneer layer.

The assembly is pressed in a stationary press with the following pressing parameters:
Temperature: 190° C.
Pressure: 50 bar
Pressing time: 45 s

The heat transfer is sufficient to cure the first binder and the second binder and get full adhesion between the HDF board, the first wood veneer layer and the second wood veneer layer. The first wood veneer layer partly fills open structures in the second wood veneer layer.

### Example 3

A powder mix according to the table below, comprising a first binder in form of melamine formaldehyde in powder form, is scattered on a surface of a HDF board forming a core. The powder mix is applied in an amount of approximately 300 g/m².

A first wood veneer layer in form of a birch veneer having a thickness of 0.55 mm and being rotary cut is provided.

A second binder is applied on the first wood veneer. The second binder is in form of a 50 wt-% melamine formaldehyde dissolved in water, applied by rolling in an amount of approximately 150 g/m².

The second binder is air dried at low temperature to a moisture content of about 6-10 wt %.

A second wood veneer in form of a sliced oak veneer nature grade having a thickness of 0.57 mm is provided. The second wood veneer layer comprises open structures in form of holes, knots and cracks.

The first wood veneer layer is applied on the HDF board with the dried first binder arranged between the core and the first wood veneer layer. The second wood veneer layer is applied on the first wood veneer layer with the dried second binder between the first wood veneer layer and the second wood veneer layer.

The assembly is pressed in a stationary press with the following pressing parameters:
Temperature: 190° C.
Pressure: 50 bar
Pressing time: 45 s

The heat transfer is sufficient to cure the binder of the powder mix layer and get full adhesion between powder mix, the HDF board and the first wood veneer layer. Full adhesion is obtained between the first wood veneer layer and the second wood veneer layer. The first wood veneer layer fills, with support of the powder layer, open structures in the second wood veneer layer.

| Powder mix | wt % |
|---|---|
| Binder: Melamine formaldehyde | 52 |
| Organic filler: wood fibres | 33.5 |
| Inorganic filler: calcium carbonate | 9.5 |
| Pigment | 5 |

### Example 4: Compression

Wood veneer layers from wood species according to the table below was pressed at 50 bar during 30 seconds. The upper press plate had a temperature of 160° C. The lower press plate was not heated. The thickness of the wood veneer layers was measured prior to and after pressing, and compression is calculated as thickness after pressing divided by original thickness in percent.

| | | | Compression % |
|---|---|---|---|
| | | | (thickness after |
| | | | pressing divided |
| | Original | | by original |
| | thickness | Thickness after | thickness prior |
| Wood specie | (mm) | pressing (mm) | to pressing) |
| Oak | 1.6 | 1.2 | 75% |
| Oak | 0.9 | 0.7 | 78% |
| Oak | 0.7 | 0.5 | 71% |
| Pine | 0.7 | 0.5 | 71% |
| Maple | 0.7 | 0.4 | 57% |
| Hickory | 0.7 | 0.6 | 86% |
| Ash | 0.6 | 0.5 | 83% |
| Walnut | 0.5 | 0.4 | 80% |

1. A method to produce a veneered panel, comprising
providing a core,
providing a first wood veneer layer,
providing a second wood veneer layer having at least one open structure,
arranging the first wood veneer layer on a first surface of the core with a first binder layer comprising a first binder and at least one filler applied intermediate the first surface of the core and the first wood veneer layer,
arranging the second wood veneer layer on the first wood veneer layer with a second binder layer comprising a second binder applied intermediate the first wood veneer layer and the second wood veneer layer,
pressing the core, the first wood veneer layer and the second wood veneer layer together to form a veneered panel,
wherein, during pressing, the first wood veneer layer is pressed into said at least one open structure of the second wood veneer layer, and after pressing, the first wood veneer layer at least partly fills said at least one open structure of the second wood veneer layer.

2. The method according to claim 1, wherein the second wood veneer layer forms an uppermost veneer layer of the veneered panel.

3. The method according to claim 1, wherein the first wood veneer layer has a thickness equal to or less than 1 mm prior to pressing.

4. The method according to claim 1, wherein the first wood veneer layer and the second wood veneer layer together have a thickness of equal to or less than 1.6 mm after pressing.

5. The method according to claim 1, wherein the first binder is applied in powder form.

6. The method according to claim 1, wherein the first binder is applied in liquid form, and dried prior to pressing.

7. The method according to claim 1, wherein the second wood veneer layer is a sliced wood veneer layer.

8. The method according to claim 1, wherein the first wood veneer layer is a rotary cut wood veneer layer.

9. The method according to claim 1, wherein the second wood veneer layer comprises an oak veneer.

10. The method according to claim 1, wherein the first wood veneer layer comprises a birch veneer.

11. The method according to claim 1, further comprising brushing the first wood veneer layer and the second wood veneer layer after pressing, a brushing depth extending into the first wood veneer layer.

12. The method according to claim 1, wherein the first binder is applied in an amount of less than 300 g/m².

13. The method according to claim 1, wherein the second binder is applied in an amount of less than 150 g/m².

14. The method according to claim 1, wherein pressing comprises applying a pressure of at least 20 bar, at a temperature of at least 160° C., during at least 10 s.

15. A veneered panel, comprising
a core,
a first wood veneer layer arranged on the first surface of the core, wherein the first wood veneer layer is adhered to the core by a first binder layer arranged intermediate the first surface of the core and the first wood veneer layer, the first binder layer comprising a first binder and at least one filler, and
a second wood veneer layer arranged on the first wood veneer layer, wherein the second wood veneer layer is adhered to the first wood veneer layer by a second binder layer arranged intermediate the first wood veneer layer and the second wood veneer layer, and wherein the second wood veneer layer has at least one open structure,
wherein the first wood veneer layer at least partly fills said at least one open structure of the second wood veneer layer.

16. The veneered panel according to claim 15, wherein the second wood veneer layer forms an uppermost veneer layer of the veneered panel.

17. The veneered panel according to claim 15, wherein the first wood veneer layer has a thickness of less than 1 mm.

18. The veneered panel according to claim 15, wherein the first wood veneer layer and the second wood veneer layer together have a thickness equal to or less than 1.6 mm.

19. The veneered panel according to claim 15, wherein the second wood veneer layer is a sliced wood veneer layer.

20. The veneered panel according to claim 15, wherein the first wood veneer layer is a rotary cut wood veneer layer.

21. The veneered panel according to claim 15, wherein the second wood veneer layer comprises an oak veneer.

22. The veneered panel according to claim 15, wherein the first wood veneer layer comprises a birch veneer.
